(19) United States
(12) Patent Application Publication
(10) Pub. No.: US 2026/0034625 A1
(43) Pub. Date: Feb. 5, 2026

(54) APPARATUS AND METHOD FOR ROTATION ASSEMBLY CENTERING IN A SUBSTRATE PROCESSING SYSTEM

(71) Applicant: ASM IP Holding B.V., Almere (NL)

(72) Inventors: SungBae Kim, Yongin-si (KR); JuSeok Jeon, Yangju-si (KR)

(21) Appl. No.: 19/280,399

(22) Filed: Jul. 25, 2025

Related U.S. Application Data
(60) Provisional application No. 63/677,046, filed on Jul. 30, 2024.

(51) Int. Cl. B23Q 3/18; B23Q 17/22

(52) U.S. Cl. CPC B23Q 3/183; B23Q 17/2233

(57) ABSTRACT

A system and method for rotation assembly centering is disclosed. The rotation assembly may be used in a substrate processing system for moving substrates between reaction chambers in the system and its centering is important for processing quality. This disclosure presents a substrate processing apparatus with a rotation arm centering function, comprising: a predetermined number of reaction chambers configured to process substrates; a rotation assembly disposed at a center of the reaction chambers; a chamber wall surrounding the reaction chambers; a transmitting unit disposed on the rotation plate, the transmitting unit configured to transmit signals to receivers; and a plurality of sensors disposed at designated places on the chamber wall, each of the sensors configured to receive a signal transmitted from the transmitting unit.

### CROSS-REFERENCE TO RELATED APPLICATIONS

This application claims priority to U.S. Provisional Patent Application Ser. No. 63/677,046 filed Jul. 30, 2024 titled APPARATUS AND METHOD FOR ROTATION ASSEMBLY CENTERING IN A SUBSTRATE PROCESSING SYSTEM, the disclosure of which is hereby incorporated by reference in its entirety.

### FIELD OF INVENTION

The present disclosure relates generally to a substrate processing system, more particularly to a substrate processing system which has a rotation assembly centering capabilities and a method of centering the rotation assembly of a substrate processing system.

### BACKGROUND OF THE DISCLOSURE

Conventionally, a substrate processing system may have multiple reaction chambers for processing the substrates. In these systems, the substrates may be switched between the reaction chambers for each step of processing and substrate moving mechanism may be provided.

A rotation assembly may be used for moving the substrates among the reaction chambers in a multi-chamber substrate processing system and the substrate movement may be rotational. For processing quality, a substrate should be placed exactly to a center of a reaction chamber during processing (etching, deposition, etc.).

For placing the substrates at the right positions, the rotation assembly should be positioned at the center of the rotation and at the right elevation (height) but after repeated processing the location of the rotation assembly may be a little off from the right position and this imprecision should be corrected as soon as possible for better substrate process quality.

Thus, the need for placing the rotation assembly at the correct position during substrate processing is great.

### SUMMARY OF THE DISCLOSURE

This summary is provided to introduce a selection of concepts in a simplified form. These concepts are described in further detail in the detailed description of example embodiments of the disclosure below. This summary is not intended to identify key features or essential features of the claimed subject matter, nor is it intended to be used to limit the scope of the claimed subject matter.

In accordance with one embodiment there may be provided, a substrate processing apparatus with a rotation arm centering function, comprising: a predetermined number of reaction chambers configured to process substrates; a rotation assembly disposed at a center of the reaction chambers; a chamber wall surrounding the reaction chambers; a transmitting unit disposed on the rotation plate, the transmitting unit configured to transmit signals to receivers; and a plurality of sensors disposed at designated places on the chamber wall, each of the sensors configured to receive a signal transmitted from the transmitting unit.

In an aspect, the rotation assembly comprises: a rotation plate placed at the center of the reaction chambers; and a predetermined number of rotation arms attached to the rotation plate, the rotation arms configured to move the substrates between the reaction chambers.

In an extended embodiment there may be provided, the system further comprises: a horizontal adjustment unit configured to adjust the rotation plate's position horizontally; and a vertical adjustment unit configured to adjust the rotation plate's position vertically.

In an extended embodiment there may be provided, the system further comprises: a controller unit electrically coupled to the sensors, the horizontal adjustment unit and the vertical adjustment unit, the controller unit configured to monitor and evaluate the signal from each of the sensors and further configured to control the horizontal adjustment unit and the vertical adjustment unit to position the rotation assembly.

In an extended embodiment there may be provided, the system further comprises: a user interface coupled to the controller, the user interface configured to receive an input from human operators and to display the signal from each of the sensors and/or current position of the rotation assembly.

In an aspect, the controller further configured to control the horizontal adjustment unit to place the rotation assembly at a predetermined position.

In an aspect, the controller further configured to control the vertical adjustment unit to place the rotation assembly at a predetermined height.

In an aspect, the input is a horizontal position and/or a vertical position of the rotation arm.

In an aspect, the signal is one of laser, infrared beam, electro-magnetic beam, and ultrasonic wave.

In an aspect, the controller further configured to evaluate by comparing the signal with the input.

In accordance with another embodiment there may be provided, a rotation arm centering method used in a substrate processing apparatus, comprising: preparing a transmitter on a rotation assembly and a predetermined number of sensors on predetermined spots of a chamber wall; transmitting signals from the transmitter to each of the sensors; evaluating, by a controller, the received signals of each of the sensors; and positioning the rotation assembly, by the controller, according to values of the evaluating.

In an extended embodiment there may be provided, the positioning further comprises: positioning the rotation assembly horizontally with a horizontal adjustment unit; and positioning the rotation assembly vertically with a vertical adjustment unit.

In an extended embodiment there may be provided, the method further comprises: getting, by a user interface, input; and displaying, by the user interface, a position status according to the values.

### BRIEF DESCRIPTION OF THE DRAWING FIGURES

It will be appreciated that elements in the figures are illustrated for simplicity and clarity and have not necessarily been drawn to scale. For example, the dimensions of some of the elements in the figures may be exaggerated relative to other elements to help improve understanding of illustrated embodiments of the present disclosure.

FIG. 1 illustrates an overview of the substrate process system according to an embodiment of the present disclosure.

FIG. 2 illustrates an overview of the substrate process system according to another embodiment of the present disclosure.

FIG. 3 illustrates another overview of the substrate process system according to another embodiment of the present disclosure.

FIG. 4 illustrates a flowchart of a method according to an embodiment of the present disclosure.

### DETAILED DESCRIPTION OF EXEMPLARY EMBODIMENTS

Although certain embodiments and examples are disclosed below, it will be understood by those in the art that the invention extends beyond the specifically disclosed embodiments and/or uses of the invention and obvious modifications and equivalents thereof. Thus, it is intended that the scope of the invention disclosed should not be limited by the particular disclosed embodiments described below.

As used herein, the term “substrate” may refer to any underlying material or materials, including any underlying material or materials that may be modified, or upon which, a device, a circuit, or a film may be formed. The “substrate” may be continuous or non-continuous; rigid or flexible; solid or porous; and combinations thereof. The substrate may be in any form, such as a powder, a plate, or a workpiece. Substrates in the form of a plate may include wafers in various shapes and sizes. Substrates may be made from semiconductor materials, including, for example, silicon, silicon germanium, silicon oxide, gallium arsenide, gallium nitride and silicon carbide.

As examples, a substrate in the form of a powder may have applications for pharmaceutical manufacturing. A porous substrate may comprise polymers. Examples of workpieces may include medical devices (for example, stents and syringes), jewelry, tooling devices, components for battery manufacturing (for example, anodes, cathodes, or separators) or components of photovoltaic cells, etc.

A continuous substrate may extend beyond the bounds of a process chamber where a deposition process occurs. In some processes, the continuous substrate may move through the process chamber such that the process continues until the end of the substrate is reached. A continuous substrate may be supplied from a continuous substrate feeding system to allow for manufacture and output of the continuous substrate in any appropriate form.

Non-limiting examples of a continuous substrate may include a sheet, a non-woven film, a roll, a foil, a web, a flexible material, a bundle of continuous filaments or fibers (for example, ceramic fibers or polymer fibers). Continuous substrates may also comprise carriers or sheets upon which non-continuous substrates are mounted.

The illustrations presented herein are not meant to be actual views of any particular material, structure, or device, but are merely idealized representations that are used to describe embodiments of the disclosure.

The particular implementations shown and described are illustrative of the invention and its best mode and are not intended to otherwise limit the scope of the aspects and implementations in any way. Indeed, for the sake of brevity, conventional manufacturing, connection, preparation, and other functional aspects of the system may not be described in detail. Furthermore, the connecting lines shown in the various figures are intended to represent exemplary functional relationships and/or physical couplings between the various elements. Many alternative or additional functional relationship or physical connections may be present in the practical system, and/or may be absent in some embodiments.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. Thus, the various acts illustrated may be performed in the sequence illustrated, in other sequences, or omitted in some cases.

The subject matter of the present disclosure includes all novel and nonobvious combinations and subcombinations of the various processes, systems, and configurations, and other features, functions, acts, and/or properties disclosed herein, as well as any and all equivalents thereof.

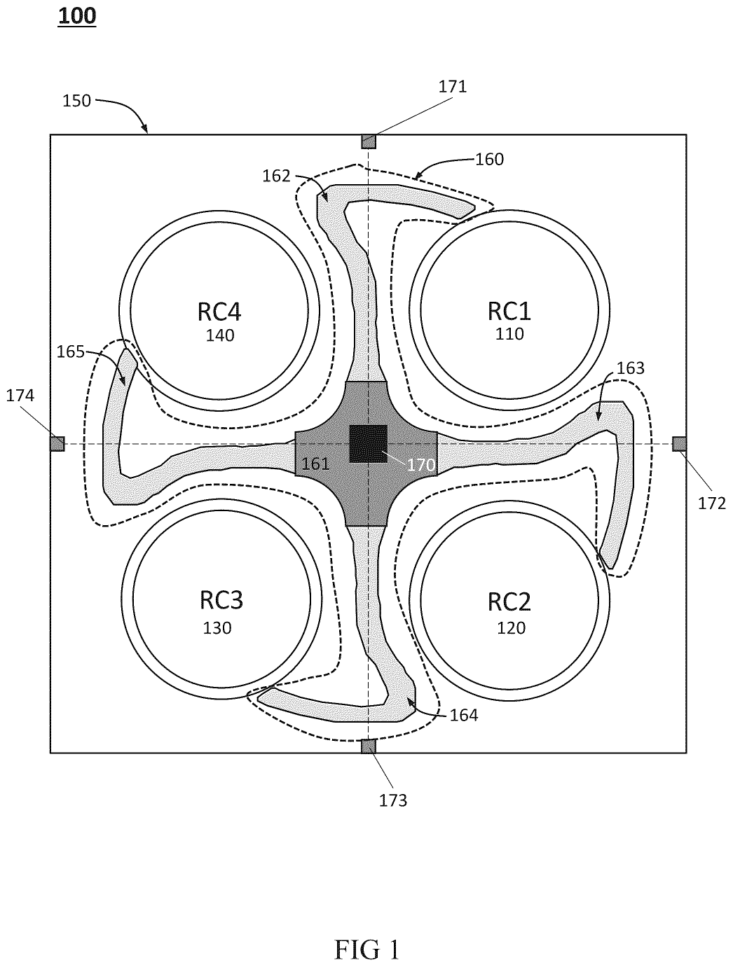

FIG. 1 illustrates an overview of a substrate processing system according to an embodiment of the present disclosure.

An embodiment of the system 100 may comprise reaction chambers (RC1, RC2, RC3, RC4) 110, 120, 130, 140. The number of reaction chambers and/or the positions of the reaction chambers may vary but in this disclosure a system with four reaction chambers may be used to make explanations simpler.

A rotation assembly 160 may be placed inside and center of the reaction chambers 110, 120, 130, 140. The rotation assembly 160 may comprise a rotation plate 161 at its own center and a number of rotation arms 162, 163, 164, 165 attached to the rotation plate 161. In this embodiment, there are four reaction chambers therefore there are four rotation arms 162, 163, 164, 165 and each of them corresponds to a reaction chamber 110, 120, 130, 140 respectively. Each rotation arm may move a substrate placed on its corresponding reaction chamber.

A chamber wall 150 may surround the chambers 110, 120, 130, 140 as well as the rotation assembly 160. On the chamber wall 150, a number of sensors 171, 172, 173, 174 may be placed at a pre-decided position respectively. The sensors 171, 172, 173, 174 may receive signal transmitted from a transmitter 170 which is attached on top of the rotation plate 161.

The position of the transmitter 170 on the rotation plate 161 may be chosen to be an exact center position of the rotation assembly 160. The elevation (height) of the transmitter 170 and the sensors 171, 172, 173, 174 will be explained below.

Before processing, the transmitter 170 may transmit signals to each of the sensors 171, 172, 173, 174. The sensors 171, 172, 173, 174 may receive the transmitted signal. By observing the sensors 171, 172, 173, 174, whether the rotation assembly 160 is located at the right place (center of the chambers) may be decided. Then, the operator may calibrate the location before substrate process starts.

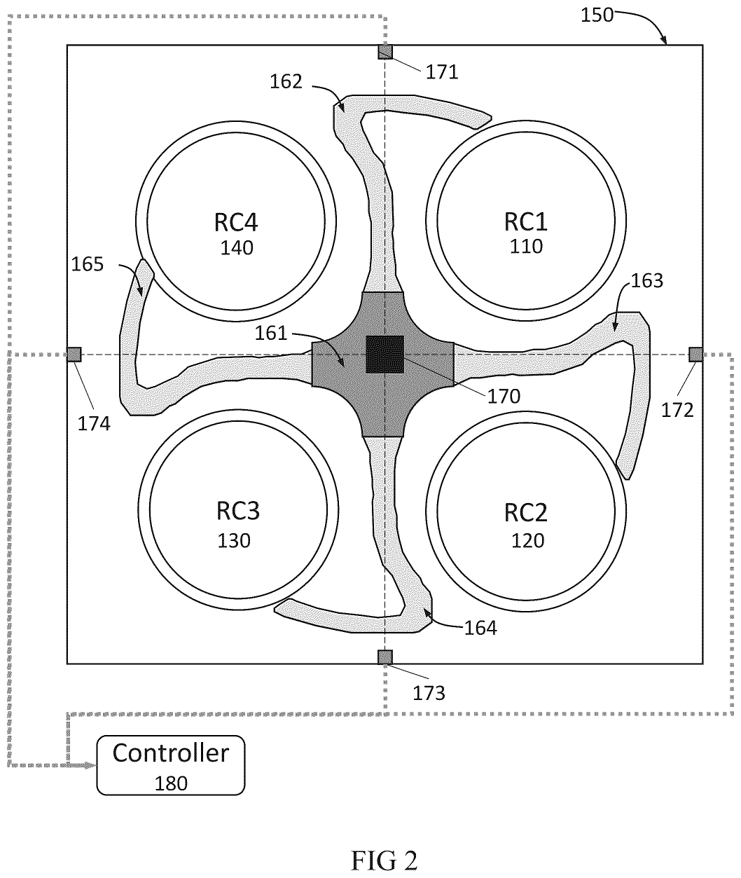

Another embodiment of the present disclosure is illustrated in FIG. 2. In this embodiment, the calibration of centering the rotation assembly may be executed automatically.

Each of the sensors 171, 172, 173, 174 may be electrically connected to a controller 180. The controller 180 may be configured to monitor and evaluate the signal from each of the sensors 171, 172, 173, 174.

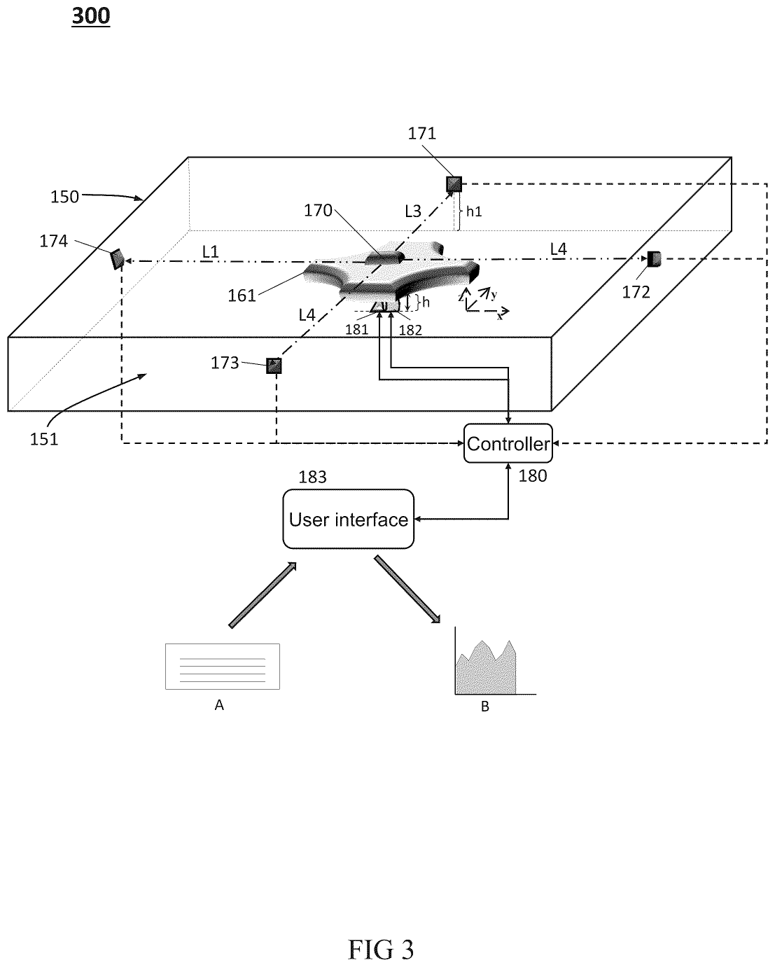

The controller 180 may be connected to a horizontal adjustment unit 181 and a vertical adjustment unit 182 illustrated in FIG. 3.

FIG. 3 illustrates a side view of the system illustrated in FIG. 2 and rotation arms and reaction chambers are omitted for simpler explanation.

The rotation plate 161 may be placed above the floor of a chamber room 151 of the system 300 by ‘h’. For simplicity the horizontal adjustment unit 181 and the vertical adjustment unit 182 are drawn inside of the chamber room 151 but they may be placed below the chamber room 151. The height ‘h’ may be a precisely calculated elevation from the floor of the chamber room 151 so that the transmitter 170 may be on the right elevation.

The horizontal adjustment unit 181 may be configured to move the rotation assembly 160 horizontally. That means the horizontal adjustment unit 181 may move the rotation assembly 160 placed on it on x-y plane.

The vertical adjustment unit 182 may be configured to move the rotation assembly 160 vertically. That means the vertical adjustment unit 182 may move the rotation assembly 160 placed on it in z-direction. That means the height ‘h’ may be changed.

The mechanism of the horizontal adjustment unit 181 and the vertical adjustment unit 182 may be electrical motor, gear, or cam, alone or combinations of them and the signal transmitted from the transmitter 170 may be laser, ultrasonic or infrared beam, or any other electromagnetic or sound beams.

A user interface 183 may be connected to the controller 180. The user interface 183 may be configured to receive input ‘A’ from an operator and display status ‘B’ of the centering and leveling of the rotation assembly 160. The input ‘A’ may be the position value of the rotation assembly 160 at the perfectly centered position and good elevation.

The centering of the rotation plate 161 (i.e., rotation assembly 160) may be accomplished as follows.

First, the transmitter 170 transmits signals L1, L2, L3, LA to each of the sensors 171, 172, 173, 174. Each sensor may show whether the signal it receives is correct in its intensity and angle (azimuth). In this case an operator may check out the sensor and calibrates the center position of the rotation assembly 160 manually. Or each sensor may send the signal it receives to the controller 180. The controller 180 may monitor and evaluate the signals L1, L2, L3, L4 to compute a location value of the rotation assembly 160 to which the transmitter 170 attached. And the input ‘A’ may be compared to the rotation assembly 160's location value derived from the signals and the comparisons may be sent to the horizontal adjustment unit 181 and vertical adjustment unit 182 by the controller 180 for the rotation assembly 160's centering and leveling following to the input ‘A’.

The sensors 171, 172, 173, 174 may be attached on the chamber wall 150 above the floor of the chamber room 151 by height ‘h1’ which is different from ‘h’.

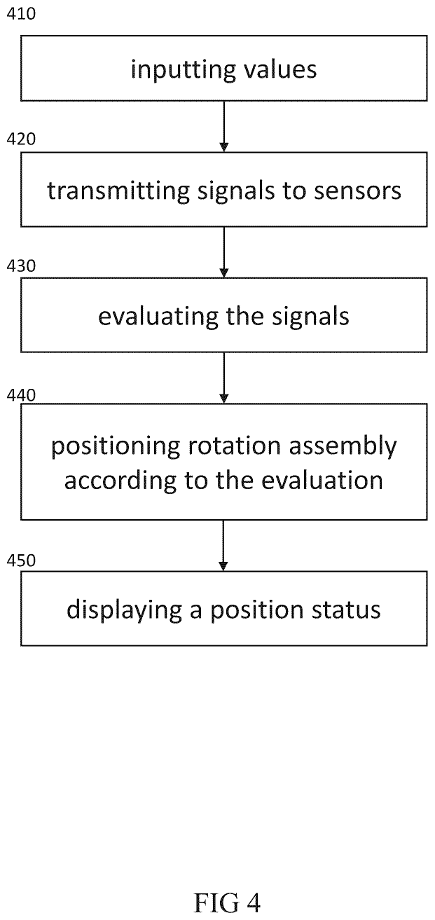

FIG. 4 illustrates the flowchart of the method according to an embodiment of the present disclosure.

In a step 410 of the method, position values may be input into the user interface 183. The input values may reside in the user interface 183 and/or in the controller 180. In a step 420 of the method, the transmitter 170 may transmit signals to each of the sensors which are attached on the chamber wall 150. After 420, the controller 180 may monitor and/or evaluate the signals it gets from the sensors in a step 430 of the method. In the step 430, the input ‘A’ may be compared with signal values from the sensors to get difference values.

In a step 440 of the method, the controller 180 controls the horizontal adjustment unit 181 and vertical adjustment unit 182 to change the position of the rotation assembly 160 horizontally and vertically with the difference values so that the intended center and level of the rotation assembly 160 may be maintained at any time of substrate processing. And in a step 450 of the method, the user interface 183 may display the status of the rotation assembly 160 (i.e., the position values of the rotation assembly 160).

The above-described arrangements of apparatus and method are merely illustrative of applications of the principles of this invention and many other embodiments and modifications may be made without departing from the spirit and scope of the invention as defined in the claims. The scope of the invention should, therefore, be determined not with reference to the above description, but instead should be determined with reference to the appended claims along with their full scope of equivalents.

1. A substrate processing apparatus with a rotation arm centering function, comprising:
a predetermined number of reaction chambers configured to process substrates;
a rotation assembly disposed at a center of the reaction chambers;
a chamber wall surrounding the reaction chambers;
a transmitting unit disposed on the rotation assembly, the transmitting unit configured to transmit signals to receivers; and
a plurality of sensors disposed at designated places on the chamber wall, each of the sensors configured to receive a signal transmitted from the transmitting unit.

2. The apparatus according to claim 1, wherein the rotation assembly comprises:
a rotation plate placed at the center of the reaction chambers; and
a predetermined number of rotation arms attached to the rotation plate, the rotation arms configured to move the substrates between the reaction chambers.

3. The apparatus according to claim 1, further comprising:
a horizontal adjustment unit configured to adjust a horizontal position of the rotation assembly; and
a vertical adjustment unit configured to adjust a vertical position of the rotation assembly.

4. The apparatus according to claim 3, further comprising:
a controller unit electrically coupled to the sensors, the horizontal adjustment unit and the vertical adjustment unit, the controller unit configured to monitor and evaluate the signal from each of the sensors and further configured to control the horizontal adjustment unit and the vertical adjustment unit to position the rotation assembly.

5. The apparatus according to claim 4, further comprising:
a user interface coupled to the controller, the user interface configured to receive an input from human operators and to display the signal from each of the sensors and/or current position of the rotation assembly.

6. The apparatus according to claim 4, wherein the controller is further configured to control the horizontal adjustment unit to place the rotation assembly at a predetermined position.

7. The apparatus according to claim 4, wherein the controller is further configured to control the vertical adjustment unit to place the rotation assembly at a predetermined height.

8. The apparatus according to claim 5, wherein the input is an input horizontal position value and/or an input vertical position value of the rotation assembly.

9. The apparatus according to claim 1, wherein the signal is one of laser, infrared beam, electro-magnetic beam, or ultrasonic wave.

10. The apparatus according to claim 5, wherein the controller further configured to evaluate by comparing the signal with the input.

11. A rotation arm centering method used in a substrate processing apparatus, comprising:
preparing a transmitter on a rotation assembly and a predetermined number of sensors on predetermined spots of a chamber wall;
transmitting signals from the transmitter to each of the sensors;
evaluating, by a controller, the transmitted signals of each of the sensors; and
positioning the rotation assembly, by the controller, according to an evaluation.

12. The method according to claim 11, the positioning further comprising:
positioning the rotation assembly horizontally with a horizontal adjustment unit; and
positioning the rotation assembly vertically with a vertical adjustment unit.

13. The method according to claim 11, further comprising:
getting, by a user interface, input; and
displaying, by the user interface, a position status according to the values.
